(19) United States
(12) Patent Application Publication
(10) Pub. No.: US 2007/0136438 A1
(43) Pub. Date: Jun. 14, 2007

(54) Method for editing media contents in a network environment, and device for cache storage of media data

(75) Inventors: Jens Brocke, Laatzen (DE); Andreas Aust, Hannover (DE); Frank Glaeser, Hannover (DE); Ralf Koehler, Hannover (DE)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(73) Assignee: Thomson Licensing Inc.

(21) Appl. No.: 11/635,425

(22) Filed: Dec. 7, 2006

(30) Foreign Application Priority Data
Dec. 8, 2005 (DE) 102005059044.6

(51) Int. Cl. G06F 15/16; G06F 15/167; H04N 7/173; H04N 5/44

(52) U.S. Cl. 709/217; 725/114; 709/203; 715/716; 709/213

(57) ABSTRACT

In the domain of studio engineering (film studio, television studio, communication studio), streaming server-based computer networks have increasingly made an entrance. The streaming servers (RSA, RSB, RSC) are used to archive the original data from the recorded articles and to make them available to the various editing computers (EA, EB) via the connected high speed network (GE). This approach has the advantage of a much greater level of availability to the original data, etc. Another advantage is that new compositions based on editing lists can be created which can then be processed in the editing device (EA, EB), and the composition's data can be requested and delivered from the server devices (RSA, RSB, RSC) in real time without this requiring fully “rendered” articles to be created and stored. When editing a new article, sections of the original data are loaded into the editing computer. Cuts are usually edited successively with coarse and fine cuts, which means that data sections frequently need to be reloaded. To relieve the network (GE) of such frequent loading operations, the invention proposes arranging a cache store (CS) in the data path between the server devices (RSA, RSB, RSC) and the editing device(s) (EA, EB), which cache store holds important parts of the loaded data sections ready. As particularly important parts, the data in an area around the start and end of a loaded data section are reloaded into the cache store (CS), because these areas are checked particularly frequently during cut editing.

### FIELD OF THE INVENTION

The invention relates to the technical field of postediting of media contents in a network environment. Media contents are understood to mean audio/video contents and computer-generated contents, such as slide shows, electronic books or other larger text or graphics documents.

### BACKGROUND TO THE INVENTION

In the domain of studio engineering, what is known as server technology is making an ever greater entrance. The original material produced is no longer archived primarily on magnetic tapes. This is increasingly being done using what are known as server devices such as video servers and audio servers, which store the original data streams on large hard discs.

Previously, the original material has been postedited using primarily standalone computer systems equipped with appropriate replaceable hard discs/magnetic tape drives. The entry of streaming server technology into studios was also accompanied by networking at the individual server devices to one another and to the postediting computers. Today, powerful network systems are available for networking. Networks based on Ethernet technology—either using fibre optics or based on copper wires—are available today with transmission rates of up to 10 GB/s.

The server-based approach to postediting in the studio or during communication production has various advantages, such as greater availability of the original material, immediate access to the original material, better technical quality, etc., and will therefore be continued.

The document US-A-2002/0116716 has disclosed an online video postediting system in which a series of server devices storing the original data from media contents are networked to one another. This server system is also accessible externally via the Internet. A computer connected to the Internet can be used by a user to access the server system and to create his own media contents—based on the original data stored there. To this end, what are known as editing lists are produced in the external computer which are transmitted by Internet to the server system, are evaluated there and are then used to deliver an appropriately compiled media data stream. Application servers are provided in the server system in order to store the editing lists and to process them upon reproduction.

From the domain of conventional use of video server technology, e.g. for video-on-demand systems, it is known practice to transmit isochronous data streams from the server to the client using the Real Time Transport Protocol RTP and Real Time Streaming Protocol RTSP protocols based

on Internet technology. In this respect, reference is made to the document by K. Schröbder; H. Gebhardt “Audio/Video Streaming using IP (Internet Protocol)” in Fernseh-und Kinotechnik, volume 54, No. 1-2/2000.

### SUMMARY OF THE INVENTION

When postediting media contents, great importance is attached to cut editing, particularly in the case of video films. Typically, the process of cut editing is a successive process in which coarse cuts and fine cuts come after one another relatively frequently, which means that sections of video contents recurrently need to be transmitted to the cut editing device via the network. What is important is that the cut positions are produced with individual frame accuracy and that the transitions are made smoothly if appropriate and without disturbance. When editing a piece of documentation which makes use of a wide variety of sources, the problem may be a special one.

The aim of the invention is to reduce the burden on the network as a result of frequent transmission of the same or similar sections of audio/video contents.

The invention solves this problem by means of the measures based on independent claims 1 and 10. In line with the invention, in the case of a method for editing media contents, particularly audio and/or video articles, in a network environment, the data path between the server device and the editing device contains a cache store which buffer-stores parts of the media contents around the start and end of a loaded section for the purpose of fast retrieval by the editing device. The cache store is also known by the term “Cache Memory”. Buffer-storage of these critical passages around the start and end of a loaded section has a very advantageous effect for the postediting in a network environment. This allows multiple repetition of the video content in the network to be avoided. In one embodiment, the cache store may be part of the actual editing device.

The measures presented in the dependent claims allow developments and improvements for the inventive method. The Real Time Transport Protocol RTP is suitable for transmitting the data in the network, with the Real Time Streaming Protocol being able to be used for controlling the transmissions of the various sections. Both protocols are suitable for real time transmission of data streams.

The editing device creates and stores what is known as an editing list, e.g. cuts list, for the new composition. For playing back the article compiled in this manner, it is advantageous if the editing list is processed such that an RTSP command is produced for each data section in the new composition. This RTSP command is then passed to the server device, which delivers the desired data using RTP.

The start and end of a data section are characterized in the media domain, particularly the audio and video domains, by means of time statements. It is advantageous if the “Range” parameter indicated within an RTSP command is the start time and the end time for a data section in SMPTE time format. This allows the data to be characterized with individual frame accuracy.

It is very advantageous if for the purpose of buffer-storing the data sections around the start and end of a requested section the respective RTSP commands for the request for the section are evaluated and the time statements they contain for the start and end of the section are taken as a basis for producing new RTSP commands which relate to the reloading of the important parts of the media contents at least around the start and end of the requested section. This allows the reloading process to be fully automated. It is advantageous if a particular period is stipulated, particularly a number of seconds before and a number of seconds after the relevant time.

In the studio domain, it is desirable for the data to be transmitted in uncompressed form, so that no quality losses have to be accepted. The method described here can also be applied to the known practice using proxy files without restriction, however. When using proxy files, compressed versions of the original files are used in order to be able to operate with a greater resource saving. Cuts lists which have been created on the basis of the compressed files are applied to the uncompressed original files during mastering.

The invention also relates to a device for buffer-storing media contents for a method for editing media contents in a network environment. For this device, the invention provides that it has a cache store which is to buffer-store parts of requested media contents around the start and end of a requested section.

Other advantageous measures for such a device are listed in dependent Claims 10 to 15.

### BRIEF DESCRIPTION OF THE DRAWINGS

Exemplary embodiments of the invention are illustrated in the drawings and are explained in more detail in the description below.

In the drawings:

FIG. 1 shows a network system having a plurality of server devices and also two editing devices;

and FIG. 2 shows a network having a plurality of server devices and also an editing device and an upstream device for buffer-storing parts of the media contents which are stored on the server devices and which are of particular importance for postediting.

### DETAILED DESCRIPTION OF THE INVENTION

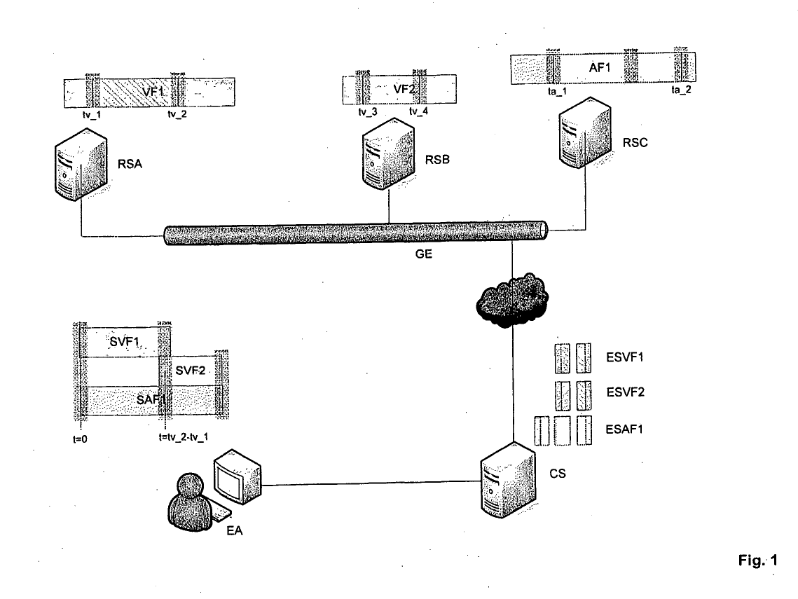

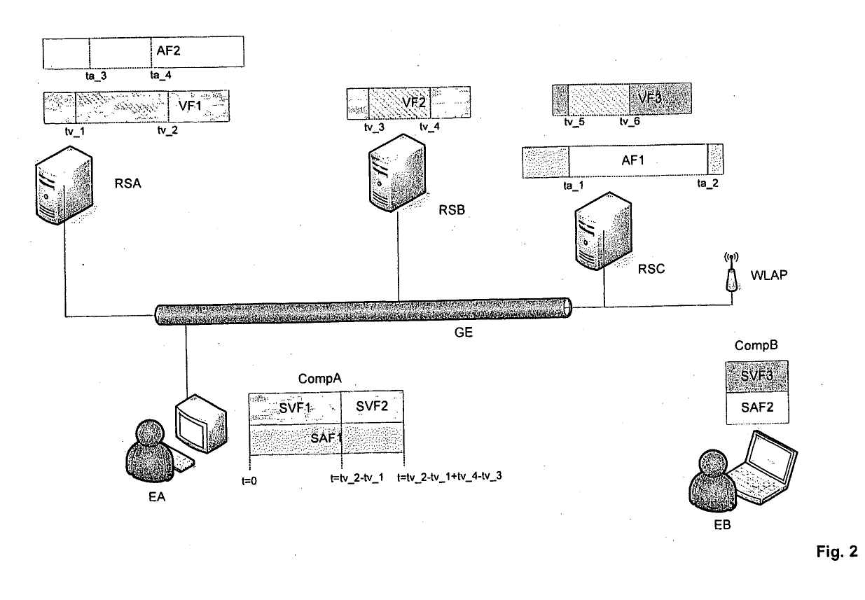

In FIG. 1, the reference symbols RSA, RSB and RSC denote three different server devices which contain implementations of the protocols RTP and RTSP. These server devices store the starting material,. e.g. video material or audio material recorded by a camera. The reference number VF1 denotes a first video document and accordingly the reference numbers VF2 and VF3 denote a second and a third video document. In addition, FIG. 1 shows .that it is also possible for audio documents to be stored. By way of example, the server device RSC stores an audio document AF1 and the server device RSA stores an audio document AF2. The individual server devices are connected to one another by means of a network. The network GE is a high-speed network, such as a 10-GB Ethernet network. The network GE has postediting devices EA and EB connected to it. In this case, the figure shows that the second postediting device EB is connected wirelessly to the network GE by means of a high-speed transmission link, the access point of said network being identified by WLAP in FIG. 1. The transmission system WIFI is suitable for this, for example.

Each postediting device has access to the data stored on the individual server devices RSA to RSC via the network GE. For such postediting devices, applications are known which allow non-destructive, nonlinear postediting of video material and audio material on a document basis, with editing lists being created.

In this case, the editing list is the new composition without itself comprising the associated data content. The recorded video and/or audio material remains stored in the original content on the server devices. In the postediting device, the user produces the editing list, which, in a simple case, may contain the following entries, for example:
at a time T=0, play back the section of video file VFl on RTP server A, from position tv_1 to position tv_2;
at time T=0, play back the section of audio file AF1 stored on RTP server RSC, from position ta_1 to position ta_2;
at time T=tv_2, play back the section of video file VF2 on RTP server RSB from position tv_3 to tv_4.

This editing list would be used to describe the composition identified by the reference symbol CompA in FIG. 1. The composition is shown in the form of a timeline.

A second example of an editing list for a composition CompB has the following entries:
at time T=0, play back a section of the video document VF3 on RTP server RSC from position tv_5 to position tv_6;
at time T=0, play back a section of the audio document AF2, stored on RTP server RSA, from position ta_3 to position ta_4.

The composition CompB is likewise shown in FIG. 1. For playback in the respective editing device, every article composed in this manner is converted by an appropriate software program into individual RSTP commands which are transmitted to the associated server device via the network. In this case, the time statements in the editing lists are preferably indicated on the basis of the SMPTE time format in the form hour:minute:second:frame number, so that the data can be transmitted with individual frame accuracy. The RTSP protocol itself is known, which means that the details of this protocol do not need to be discussed below. Some RTSP commands are specified for initializing a session, requesting data and for the subsequent responses. The text below assumes that an RTSP session has been set up and is in existence. For the first entry in the editing list for composition B, the associated RTSP playback request would have the following appearance:
PLAY rtsp://rtpserver_C.com/VideoFile_{—}3 RTSP/1.0
CSeq: 2
Session: 23456789
Range: smpte=0:10:00-0:15:00

The first line of this command contains the URL for the video document VF3 on the RTP server RSC. The statement in the second line C-Sequence:2 relates to the indication of a sequence number which is allocated by the request device. The third line contains the identification number for the session and the fourth line then contains the “Range” parameter with the two time statements in SMPTE format, from where to where the video document VF3 is intended to be played back.

Should the person editing composition B also have inserted a commentary track into his composition then this can also be stored on a server device. This can be done using the RTSP command “Record”, and the commentary text can be recorded as an additional recording track for the sound.

FIG. 2 shows an arrangement of three streaming server devices RSA to RSC which are connected by means of the network GE. An editing device EA is likewise connected to the network GE, with a device for buffer-storing CS media contents also being arranged between the editing device EA and the network GE. In line with the invention, the device for buffer-storage CS is intended to be used to relieve the network GE of repeat transmissions of media contents. This is done such that it holds frequently recurring sections of the media contents ready as in a cache memory arrangement or a proxy server.

One problem in this case is stipulating rules for how the frequently required media contents are to be identified. In this context, the invention takes the route that the areas around the start and end of a section of a media content which has been requested by the editing device are reloaded into the device for cache storage CS as a precaution. To this end, the device evaluates the RTSP commands which are sent from the editing device to the server devices. Experience shows that a new composition comprises a compilation of individual sections of recorded starting material. The cut boundaries with individual frame accuracy which are required in the case of new video compositions are, as described above, often stipulated accurately only little by little. Therefore, in line with the invention, for each section of a media document which is to be edited the areas around the boundaries of the respectively considered section of a media document are transferred to the cache store CS as a precaution. These boundary areas are respectively identified by a greyscale pattern in FIG. 1. A special feature is shown for the audio document AF1. This is because in that case an area from the centre of the data section shown is likewise loaded into the buffer store CS between the times ta_1 and ta_2. Since, for the two video sections played back in parallel with the audio section, the conditions for cache storage are met during playback of the audio section, the relevant part from the centre of the audio section is also buffer-stored.

The relevant data sections are reloaded into the buffer store CS using the RTSP protocol. In this case, it is possible to define what area around the limit value needs to be requested. One implementation may involve requesting from the streaming server the area relating to a number of seconds before and a number of seconds after the respective limit value. An example value is the value 5 seconds before and after the respective start, end of the requested data section, for example.

To transmit the areas frequently requested by the editing device EA, just one respective data stream is then required between the memory CS and the editing device EA. The rest of the network GE is freed of this data traffic.

The buffer store can handle the RTSP commands in a similar manner to the known method for buffer-storing HTTP requests (HTTP Proxy). In this case, all requests from editing devices are intercepted, interpreted and forwarded. The forwarded requests are modified possibly in line with the method described here.

In another implementation, the buffer-store arrangement can also be integrated in the editing device EA.

What is claimed is:

1. Method for editing media contents, particularly audio and/or video contents, in a network environment, where media contents are stored on a number of server devices (RSA, RSB, RSC), where sections of media contents are loaded into an editing device (EA, EB) via the network, and an editing list is created in order to describe a new composition comprising the loaded media contents, characterized in that the data path between the number of server devices (RSA, RSB, RSC) and the editing device (EA) contains a cache store (CS) in which are provided parts of the media contents around the start and ed of a loaded section for the purpose of faster retrieval.

2. Method according to claim 1, where the Real Time Transport Protocol (RTP) is used for transmitting the sections of media contents in the network environment and the Real Time Streaming Protocol (RTSP) is used for controlling the transmission of the sections of media contents.

3. Method according to claim 2, where the editing list is processed in order to play back the new composition and the Real Time Streaming Protocol (RTSP) is used for the espective request for a data section in the new composition.

4. Method according to claim 2, where the “Range” parameter indicated within an RTSP command is the start and end times for a data section of the media contents in SMPTE format, where SMPTE stands for “Society of Motion Picture and Television Engineers”.

5. Method according to claim 1, where the RTSP command “Record” is used for transmitting commentary text relating to the new composition for archiving on one of the server devices (RSA, RSB, RSC), and the commentary text is stored as a track, particularly an audio track, on a server device (RSA, RSB, RSC) additionally.

6. Method according to claim 1, where for the purpose of buffer-storing the data sections around the start and end of a loaded section the respective RTSP commands for the request for a section are evaluated and the time statements they contain for the start and end of the section are taken as a basis for producing new RTSP commands which relate to the reloading of the important parts of the media contents around the start and end of the loaded section.

7. Method according to claim 1, where if a requested data section is intended to be played back at the same time as other data sections and the criterion for cache storage is met at a given time for at least one data section then the cache storage for the corresponding time segment is likewise performed for a concurrent data section.

8. Method according to claim 6, where the parts respectively around the start and end of the loaded section and also the part in the central area of a data section relate to a stipulated period, particularly a number of seconds before and a number of seconds after the relevant time.

9. Method according to claim 1, where the sections of media contents are transmitted in uncompressed form via the network (GE).

10. Device for the cache storage of media data for a method for editing media contents in a network environment according to one of the preceding claims, characterized in that the device (CS) has a cache store in which are provided parts of requested media contents around the start and end of a requested data section for the purpose of fast retrieval.

11. Device according to claim 10, where the evaluation means are designed such that they evaluate the request messages for the request for media contents and, on the basis of this, create separate request messages in order to load the relevant parts around the start and end of a requested data section automatically.

12. Device according to claim 10, were the evaluation means are designed to evaluate RTSP commands which are used to request the sections of media contents.

13. Device according to claim 10, where the evaluation means are designed such that if a requested data section is intended to be played back at the same time as other data sections and the criterion for cache storage is met at a given time for at least one data section then the cache storage for the corresponding time segment is likewise performed for a concurrent data section.

14. Device according to claim 10, where the evaluation means are designed to create request messages for loading the relevant parts around the start, the central area and the end of a requested section in the format of RTSP commands.

15. Device according to claim 14, where the “Range” parameter indicated within an RTSP command is the start and end times for a data section of the media contents in SMPTE format, where SMPTE stands for “Society of Motion Picture and Television Engineers”.
